(19) United States
(12) Patent Application Publication
(10) Pub. No.: US 2008/0213641 A1
(43) Pub. Date: Sep. 4, 2008

(54) Photoelectrochemical Reaction Cell

(75) Inventors: Dieter Ostermann, Dusseldorf (DE); Michael Depenbrock, Heek (DE)

Correspondence Address: THE WEBB LAW FIRM, P.C., 700 KOPPERS BUILDING, 436 SEVENTH AVENUE, PITTSBURGH, PA, 15219, US

(73) Assignee: Dieter Ostermann, Dusseldorf (DE)

(21) Appl. No.: 10/592,258

(22) PCT Filed: Jan. 18, 2005
(86) PCT No.: PCT/EP2005/000425

§ 371 Date: Mar. 25, 2008

(30) Foreign Application Priority Data
Mar. 11, 2004 (DE) 102004012303.9-45

(51) Int. Cl. H01M 8/06; C25B 1/02; C25B 9/06

(52) U.S. Cl. 429/21; 204/242; 204/280

(57) ABSTRACT

The invention relates to a reaction cell for the photoelectrochemical production of hydrogen gas, comprising a housing which is filled with an aqueous electrolyte, a pair of electrodes consisting of a first electrode of a doped conductor which is immersed in the electrolytes and a second electrode which is made of metal and which is immersed in the electrolytes and which is electrically conductively connected to the first electrode, also comprising a light source which illuminates the pair of electrodes. The reaction cell is characterized in that the electrodes are connected to each other in a flat manner, the pair of electrodes divides the reaction cell into two chambers, wherein the chambers are connected to each other in a fluidically conducting manner and the housing is provided with at least one gas outlet.

The invention relates to a reaction cell for the photoelectrochemical production of hydrogen gas, comprising a housing which is filled with an aqueous electrolyte, a pair of electrodes consisting of a first electrode made of a semiconductor which is immersed in the electrolyte and a second electrode made of metal which is immersed in the electrolyte and is electroconductively connected to the first electrode, and a light source which irradiates the pair of electrodes.

Due to its ecological advantages—the combustion produces only steam—hydrogen is considered to be the energy carrier of the future. But actually, the industrial production of hydrogen gas is still based on about 90% of petrochemical processes including fossil energy source, particularly natural gas. Another possibility to extract hydrogen consists in the separation of highly concentrated parts of hydrogen in the off-gas of refineries, industrial furnaces or chemical plants. A highly efficient possibility to produce hydrogen gas is met in the electrolysis of water, i.e. in the separation of water molecules in to hydrogen gas and oxygen gas by means of water conducted electrical current. But in the global energy balance and in the evaluation of eco-friendliness of this process, it has to be considered at which cost and from which energy carrier the electrical energy which was used for electrolysis was made available. An economical industrial execution of electrolysis of water by means of using the sun light failed till now due to the low efficiency of available solar cells. Therefore, the goal is to develop reaction cells by means of which hydrogen gas can be directly produced from an aqueous electrolyte by using the radiation energy of the sun light.

Reaction cells of above mentioned kind are known, at least related to their fundamental structure, from scientific literature. So, an electrochemical cell consisting of two individual receptacles each being filled with water as electrolyte connected by a conduction is described in the article “Electrochemical Photolysis of Water at a Semiconductor Electrode” (Nature Vol. 238, 7, Jul. 1972). In the first receptacle an electrode consisting of a conductor in form of a n-doped TiO₂-crystall is immersed in the electrolyte. This electrode is connected with a platinum electrode placed in the second receptacle by means of an external load resistor. By irradiation of the TiO₂-electrode with visible light through a window placed in the wall of the first receptacle, electron-hole-pairs are formed at the surface of the TiO₂-semiconductor crystal which are separated in the electrical field present in the semiconductor at the contact surface to the electrolyte While, as according to the theory, the electron holes oxidize the oxygen contained in the water molecules at the surface of the TiO₂-crystall by formation of oxygen gas, electrons run to the platinum electrodes via the external electric circuit where they reduce hydrogen ions (protons) by formation of hydrogen gas.

A compensation of ion concentration between both receptacles occurs through the conduction connecting both receptacles which is provided with an ion permeable membrane to avoid an exchange of liquid between both receptacles.

While authors are reporting about a successful decomposition of water under formation of hydrogen gas and oxygen gas, the documented experimental results with the above mentioned reaction cell could not be reproduced in the following years the way that finally, the reaction cell cannot be considered as suitable for production of hydrogen gas.

Further principles of construction of photoelectrochemical reaction cells are described in the Encyclopedia of Electrochemistry (Volume 6, Semiconductor Electrodes and Photoelectrochemistry, P. 347-357, Editor S. Licht). They each comprise one receptacle, e.g. a glass pipe, which is subdivided in individual chambers by several pairs of electrodes having the shape of a plate, connected to each other in a flat manner, each consisting of a doped semiconductor electrode (e.g. n-TiO₂,n-Pb₃O₄ or n-CdSe) and a backplate electrode of platinum, lead, CoS or another material. The pairs of electrodes, themselves, are arranged in the receptacle like bulkheads the way that no liquid or gas exchange between the individual chambers is possible. Thereby the surfaces of the semiconductor electrode and the backplate electrode of respective neighbouring pairs of electrodes stand face to face to each other. Furthermore, the pairs of electrodes are tilted the way that the respective semiconductor surfaces are irradiated by the light shining through the receptacle, wherein the formation of electron-hole-pairs takes place. The chambers are filled with aqueous electrolytes of different compositions. To create a closed electric circuit, both external chambers are connected to each other with a salt bridge. During operation, only a charge transfer through the respective electrolytes takes place while in both external chambers, on one side, oxygen is formed in an oxidation reaction and on the other side of the cell, hydrogen gas is formed in a reduction reaction.

The disadvantage of above mentioned cell is first of all its complicated structure as well as the fact that different electrolytes are used in the different chambers that increase operation expenses. Moreover, it concerns just laboratory set-ups whose industrial usability is uncertain.

It is thus an object of the invention to create a reaction cell of above mentioned kind which reliably and reproducibly allows the Production of hydrogen gas in a photoelectrochemical reaction and. which is characterised by a particularly simple structure for an industrial production in series. The problem is solved by means of a reaction cell according to the preamble of patent claim 1 in that the electrodes are connected to each other in a flat manner, in that the pair of electrodes subdivides the reaction cell in two chambers wherein the chambers are connected to each other in an ion conducting manner and in that the housing comprises at least one gas outlet.

As the experiments in the studies have shown, with the reaction cell developed according to the invention, hydrogen gas can be produced from an aqueous electrolyte in permanent operation. The decisive reason for the reliable process of the photoelectrochemical reaction is the direct contact of both electrodes without interposition of an electrical conductor, e.g. of a copper wire or a load resistor as it is the case in the prior art. It is decisive that in the case of a metallic second electrode an ohmic contact is formed between the semiconductor electrode and the metallic electrode allowing a free exchange of charge carriers between both electrodes. In case of a second electrode consisting of a oppositely doped semiconductor with respect to the electrode, a pn-junction is formed at the contact surface between both electrodes. Furthermore, the reaction cell is characterised by a particularly simple structure which manages with some very simply structured and robust components and which is also suitable for an industrial production of hydrogen gas in a continuous process free of maintenance. By subdividing the reaction cell in two chambers by a suitable arrangement of the pair of electrodes, partial reactions can occur in separate spaces the way that a mix of the produced gases during their production and therefore impurity of produced hydrogen gas is avoided. At the same time, due to the ion conducting junction of both chambers, an undisturbed ion transport through the electrolyte can occur. In the simplest case, both chambers are connected to each other in a liquid conducting manner. It is also possible to realise the ion conducting connection between both chambers by an ion permeable membrane.

For an efficient operation of the cell, it is important that the light from the light source irradiates the semiconductor electrode as extensively as possible and with high intensity the way that numerous electron-hole pairs are formed at the contact surface to the electrolyte. Consequently, an arrangement of the pair of electrodes is preferred wherein the electrodes are connected with each other at the backside of the first electrode with respect to the high incidence in a flat manner the way that the free, not connected surface of the first electrode is directly exposed to radiation. Fundamentally, the pair of electrodes can be lined up relatively to the light source in such way that the metallic second electrode is exposed to radiation and—conditioned by a sufficiently low thickness of the second electrode—mostly transmits the radiation. Doing so, the radiation penetrates into the first electrode through its connected surface (semiconductor) where it is absorbed by formation of electrode-hole pairs.

A connection in a flat manner of both electrodes can fundamentally be reached by pressing, screwing or by another common process of connection of two surfaces in a flat manner. A connection in a flat manner can be well reached in vacuum evaporation the second electrode, in case of a metallic electrode material, at one side of the first electrode. Beside best connection, it also has the advantage that the material used for the second electrode can be used very economically, which leads to a reduction of production costs of the reaction cell. By vacuum evaporation the metal of the second electrode on the first electrode, an extremely thin layer of metal can be formed on the first electrode which is particularly advantageous when the second electrode is irradiated by the light source since in this case, the important thing is that a large part of radiation is guided to the semiconductor electrode underneath.

Fundamentally, the first electrode (semiconductor) can also be deposited on the second electrode (metal or semiconductor) the same way. So, it is possible to induce epitaxial growth of a layer of semiconductor on a layer of metal or a layer of semiconductor.

Both electrodes, themselves can be formed in different ways. It is particularly proven to be functional when the electrodes each have a plane surface, particularly having the shape of a plate each, provided with a front side and a back side wherein the front side of the first electrode is irradiated by the light source and the back side of the first electrode is connected to the front side of the second electrode in a flat manner.

As light source, every light source which emits photons with a photon energy which delivers the necessary photoelectric voltage to decompose the electrolyte (e.g. water: 1.23 V), is basically suitable for. In this case, it should be considered that the photon energy is conform with the band gap of the used semiconductor material.

The light source can be arranged outside the reaction cell but also within the cell. To allow a particularly economic and eco-friendly operation of the reaction cell, sunlight as light source is preferred. In case of an open housing, an external light source can radiate from top into the cell on the surface of the first electrode. But the light radiation through the housing wall is particularly advantageous. Therefore, the housing wall is made, either of a light transparent material such as plexiglass or of a material impervious to light and in this case, has a window for light irradiation. Stainless steel or different plastics can be suitable as housing material. Metals such as copper, aluminium, gold, brass or nickel are also suitable. An important criterion by choosing the material is the fact that the used electrolyte should not react as corrosive on it. It is clear that the chosen housing material should not be permeable for the produced gas, particularly the hydrogen gas. It should also not be able to store the gas.

In case of a window to be irradiated, the window should be possibly wide band transparent with respect to the radiated light. Particularly the UV Fraction of the irradiated light should possibly pass the window free of absorption since by UV photons, electrons-hole pairs can be produced also in semiconductors with a particularly large band gap. Consequently, the window should consist of an UV transparent material. Therefore, quartz glass, Plexiglas, ZnSe, ZnS, borosilicate glass, MgF2 or sapphire are particularly suitable for.

Beside a wide range of suitable housing material, the housing geometry can also be modelled very variably. For example, rectangular geometries are suitable.

Reaction cells which housing is closed at all sides excluding at least one gas outlet are proved to be particularly robust. The gas produced in the cell during the photoelectrochemichal reaction can be let out through the gas outlet without problem. It is practical that the gas outlet can be closed gas tight by a valve. This fact allows for example a simple transport of the reaction cell without the danger to contaminate the electrolyte.

To allow a complete separation of hydrogen gas produced during reaction, from the remaining gas, a hydrogen permeable membrane can be arranged in the gas flow escaping the gas outlet of the reaction cell. The membrane can particularly consist of a layer of metal which let pass hydrogen molecules while other gas molecules are held back. Membranes made of palladium alloys are particularly suitable in this case.

Another easy to realise constructive possibility to completely separate the gases formed at both surfaces of electrodes consists in the fact that both chambers formed by the pair of electrodes in the cell are provided with one gas outlet each through which the gases can be separately lead off.

According to a further functional embodiment of the invention, it is envisaged that the reaction cell is provided with a heat exchanger. By means of a heat exchanger, reaction heat can be lead off on the one hand. On the other hand, freezing of the electrolyte during winter operation of the reaction cell can be avoided by the fact that a warmed up liquid is guided through the heat exchanger. Practically, the heat exchanger should be installed at the back side of the light in the reaction cell.

The individually used aqueous electrolyte can be composed in different ways. The reaction cell can particularly be operated with water as electrolyte without problem and permanently wherein hydrogen gas and oxygen gas is produced. To produce a particularly pure gas, it should be distilled water (aqua bidest). But it is also thinkable to use further electrolytes such as aqueous acid solutions wherein other gases instead of oxygen can be produced beside hydrogen. In this case, the position of the corresponding element in the electrochemical series is decisive.

To further increase the purity of the produced gas, it is best to supplementary degas the electrolyte before to eliminate gases dissolved in the electrolyte.

If water is used as electrolyte, antifreezing agent can also be added to it to avoid freezing at low temperatures like in the case of using a heat exchanger.

The first electrode of the reaction cell consists of a doped semiconductor. Therefor, different materials of semiconductors, direct as well as indirect semiconductors can be used. Particularly, the first electrode can consist of a semiconductor of the group Tick, SrTiO₃, Ge, Si, CU₂S, GaAs, CdS, MoS₂, CdSeS, Pb₃O₄ or CdSe. Titanium dioxide has been proved to be particularly suitable which can be produced industrially in big quantity at low cost, e.g. to be used as white pigment. TiO₂ can be used as semiconductor electrode in different modifications in the reaction cell. Among others, ultra thin TiO₂-layers, TiO₂-films, polycrystalline TiO₂, sintered TiO₂ powder as well as special TiO₂-crystal structures such as rutile, anatase or brookite are thinkable.

Among others, doping semiconductor results in the fact that above the valence band respectively underneath the conduction band in the forbidden zone (energy-Gap), further states chargeable by charge carriers are formed the way that there is a practically reduced band distance in the semiconductor.

It can be used so far that also in case of semiconductors with a big band gap such as in case of TiO₂ (band gap 3.1 eV that corresponds to a limit wavelength of about 400 nm), also low energy fractions of the visible spectrum can be used. Herein, n-doping as well as p-doping is a possibility. In the case of an n-doped semiconductor, an electrical field is created at the contact surface to the electrolyte in the semiconductor that results in the fact that electron-hole pairs formed by irradiation of semiconductor surface are separated the way that the negative loaded electrons run off to the inside of the semiconductor and further to the second electrode connected in a flat manner while the positive loaded holes remaining at the surface oxidize the electrolyte. Doing so, consequently, hydrogen gas is produced on the surface of the second electrode by reduction of electrolyte. In the case of p-doped semiconductor, the case is the other way around, with other words, the developing electrical field is directed the way that the holes are discharged in the second electrode connected in a flat manner while the electrons at the surface of the semiconductor reduce the electrolyte wherein hydrogen gas is formed.

In case of using a doped TiO₂-crystal as first electrode, designed the irradiated surface of this electrode is advantageously as (110)—or (100)—crystal plane. This promotes the dissociation of the electrolyte molecules, particularly water molecules, at the surface of the electrode.

In the case of most of the mentioned semiconductor materials, only a relative small, highly energetic part of the visible spectrum can be used for the photoelectrochemical reaction due to the big band gap. An extension of the usable spectral region towards low energy fractions can be reached by adsorption of dye molecules at the irradiated surface of the semiconductor. Doing so, the dye molecule is electronically excited by the irradiated light and consequently releases the excited electron to the conduction band of the semiconductor. This process, known as “electron injection”, has been proved to be effective, particularly in case of TiO₂-semiconductors.

Another possibility to extend the usable light spectrum consists of adsorbing platinum atoms on the surface of the first electrode, preferably in form of clusters, by means of which interface states, i.e. supplementary permitted energy states within the forbidden zone of the respective semiconductor are created which extend the usable spectral range to low energy light. It is clear that the surface of the first electrode should not be completely covered by platinum since consequently, a system of metal-semiconductor-metal will be created which is not usable for a photoelectrochemical reaction.

The second electrode connected to the first electrode in a flat manner consists of a metal or a contrarily doped semiconductor. In case of a semiconductor, the above mentioned semiconductor materials can also be used. A p-n transition is formed between both semiconductor electrodes. In case of using a metal, this must develop an ohmic contact when being contacted to the semiconductor material of the first electrode. When choosing a suitable metal, it should be further considered that this does not possibly react with products of reaction or the electrolyte e.g. that it does not form or only marginally forms oxides. The elements Ru, Rh, Pd, Ag, Os, Ir, Pt, Au, AI, Cr, Cu, Ni, Mo, Pb, Ta and W are particularly suitable. As already mentioned before, a particularly advantageous method of contacting both electrodes consists in vaporising the second electrode on the first one, so the stainless steel can be used correspondingly economically and so at a relatively low budget.

According to a further embodiment of the invention, a plurality of pairs of electrodes are provided in the reaction cell wherein the respective first electrodes of the pairs of electrodes consist of different semiconductor materials. In this case, the semiconductor materials should be chosen according to their individual band gaps the way that they absorb in different spectral regions such that a possibly wide spectral range of the light source, particularly of the sunlight can be used to form electron-hole pairs and so to start the reactions of reduction and oxidation. For example, three pairs of electrodes can be provided wherein the first electrode of the first pair of electrodes consists of TiO₂, the first electrode of the second pair of electrodes consists of SrTiO3 and the first electrode of the third pair of electrodes consists of GaAs and the respective second electrodes consist of vaporised platinum.

It is preferred that the pairs of electrodes are arranged one behind the other in the direction of light incidence wherein the first and the second electrodes of the pairs of electrodes are facing each other, which means that at least, the second electrode of one pair of electrodes is facing the light source. In this case, particularly the respective metal electrodes should be thin enough to avoid a high absorption of radiation in the metal. This can be reached without problem by vaporising an extremely thin layer of metal on the respective semiconductor electrodes. Due to the fact that the first and the second electrodes of the pairs of electrodes face each other, according to the invention only one kind of gas is produced in the chambers established by the pairs of electrodes, respectively. That means that in case of a n-doped semiconductor exclusively hydrogen gas is produced between the metal electrodes of neighbouring pairs of electrodes wherein the metal electrodes are facing each other. The hydrogen gas is advantageously lead off through a gas outlet assigned to this chamber from the reaction cell to a gas accumulator.

To be able to use the illuminated light energy particularly for the photoelectrochemical reaction, the respective first electrode of the pairs of electrodes, which are arranged one behind the other in the direction of irradiation, should have a smaller band gap with respect to the first electrode of the pair of electrodes that is arranged ahead with respect to the direction of irradiation. That means that first of all, the first electrode of the first pair of electrodes having the largest band gap is irradiated wherein there, only the photons with the highest energy are absorbed.

The following first electrode in radiation direction (second pair of electrodes) having a smaller band gap absorbs photons of lower energy as well as the high energy photons which are transmitted through the first electrode of the first pair of electrodes. In the following first electrode (third pair of electrodes) which again has a smaller band gap, photons with still lower photon energy are absorbed as well as all high energy photons which penetrate in this electrode. This proceeds till the first electrode of the last pair of electrodes in radiation direction by means of which best exploitation of energy of the irradiated light is reached.

Furthermore, it is also an object of the invention to provide a device for converting light energy into electrical energy that is constructed in a simple and compact way and allows a use as current generator independent from the location.

The problem is solved according to the invention by a device for converting light energy into electrical energy with a reaction cell according to one of claims 1 to 27 in that an anode-cathode arrangement in the reaction cell or in another cell that is connected to the reaction cell through at least one gas conduction is provided wherein the anode and the cathode are conductively connected to each other through an external electric circuit to which an electrical consumer can be connected to and wherein the anode and the cathode are arranged such that the gas produced at the first and the second electrode of the pair of electrodes flows around the anode and the cathode.

In the device according to the invention, first of all, hydrogen gas is formed at the electrodes of the pair of electrodes in the above mentioned way and for example by using water as electrolyte oxygen gas is formed. According to the invention, an extra anode-cathode arrangement is provided in the device which is arranged such that the gases flow around the anode and the cathode,. Doing so, the anode-cathode arrangement can be arranged in the reaction cell. But it is also possible to place the anode-cathode arrangement in another cell which is connected to the reaction cell by means of at least a gas conduction to transport the gases produced in the reaction cell to the anode-cathode arrangement. Then, the gases that flow around the anode and the cathode are reduced respectively oxidized at the anode and the cathode in opposite redox reactions with respect to the reactions taking place in the reaction cell wherein the charge carriers obtained by means of oxidation flow to the backplate electrode through the external electric circuit connecting the cathode to the anode. An electrical consumer can be connected to this electric circuit which is supplied with electrical energy in this way. The ions produced by the reaction of oxidation or reduction, respectively, react with each other to molecules of the electrolyte in the reaction cell. If water is used as electrolyte, the produced hydrogen gas and oxygen gas react wherein water is produced.

According to another embodiment of the invention, the anode-cathode arrangement is designed as fuel cell. Therefore, both electrodes are connected to each other by a exchange membrane through which the hydrogen ions which are formed at the anode can move to the cathode. There, they can for example react with negative charged oxygen ions to water.

As already mentioned, the charge neutralization takes place through the external electric circuit. The particular advantage of the fuel cell is the fact that it can be integrated in the reaction cell without problem wherein it should preferably be arranged above the pair of electrodes the way that the gases produced at the surface of the electrodes of the pair of electrodes can intensively flow around the fuel cell. Moreover, it is particularly advantageous to use a low temperature fuel cell in the reaction cell which has a working temperature of 80° C. This way, the reaction cell is not extremely stressed in matter of temperature.

According to a particularly advantageous embodiment of the invention, it is provided that several pairs of electrodes and several fuel cells are arranged in alternating order beside each other in the reaction cell wherein an external consumer can be connected to the respective external electric circuit of the fuel cells. A closed system can be established with this kind of arrangement in which the gases formed at the pairs of electrodes are consumed by means of the respective neighbouring fuel cells which individually or parallel connected act as current source, and are converted to molecules of the electrolytes, particularly water.

According to an alternative embodiment, the anode-cathode arrangement is placed in another cell and is formed as a galvanic cell. The gases escaping from the reaction cell, e.g. hydrogen gas and oxygen gas, separately flow around the anode and the cathode which are preferably made of platinum.

For this purpose, the gases are lead off the reaction cell through a common conduction in the other cell where they are separated at a membrane the way mentioned above. Preferably, the gases are separately lead to the other cell by means of two conductions the way that a separation later on is avoided. Both electrodes, anode and cathode, are immersed in an electrolyte, e.g. in diluted sulphuric acid. While doing so, hydrogen gas is oxidized to hydrogen ions at the anode. Like in case of fuel cell, the transport of the electrons from the anode to the cathode is effected through an external current circuit to which an electrical consumer can be connected. The reaction of the hydrogen ions passing through the electrolyte with the existing oxygen and the electrons transported through the external electric circuit to water occurs at the cathode:

O₂+4H⁺+4e⁻−>2H₂O

An operation ratio of about 60% can be determined for the fuel cell as well as for the galvanic cell.

Following, the invention is explained by means of drawings representing examples of construction. They show:

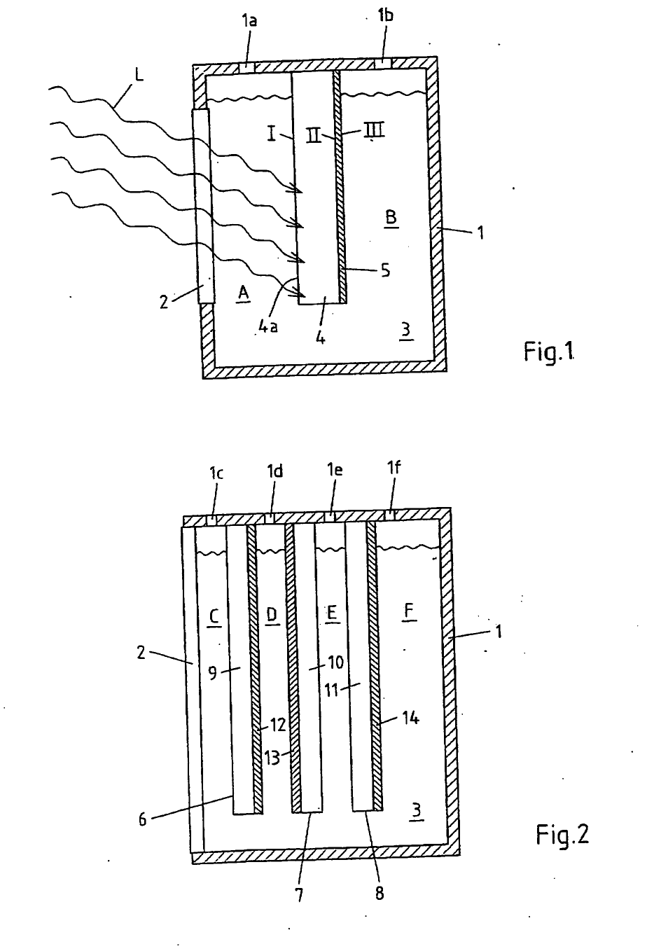

FIG. 1 a reaction cell for the photoelectrochemical production of hydrogen gas with a pair of electrodes in a highly schematized lateral sectional view,

FIG. 2 the reaction cell of FIG. 1 in a different construction with respect to FIG. 1 with three pairs of electrodes in lateral sectional view,

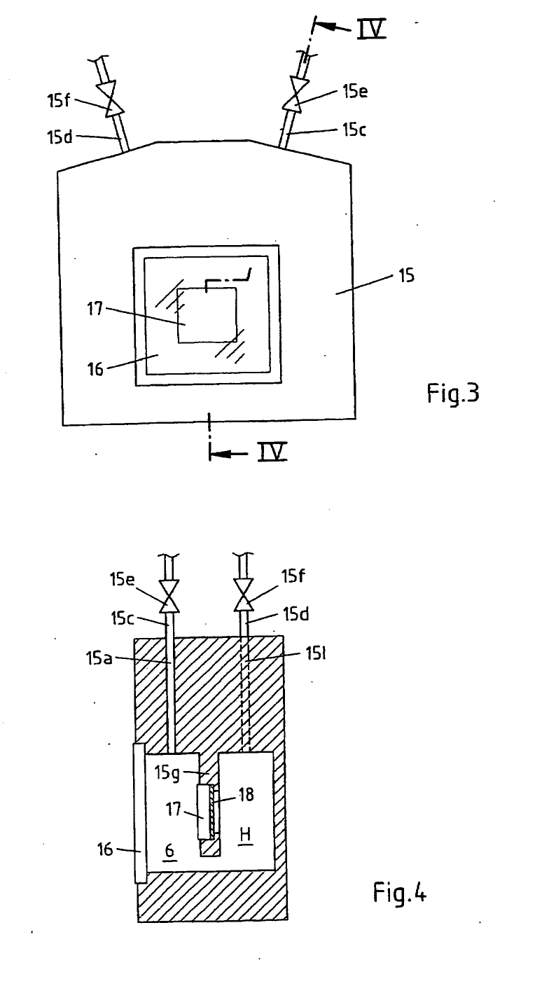

FIG. 3 the reaction cell of FIG. 1 in an example of construction in front view and

FIG. 4 the reaction cell of FIG. 3 in lateral sectional view according to line IV-IV of FIG. 3,

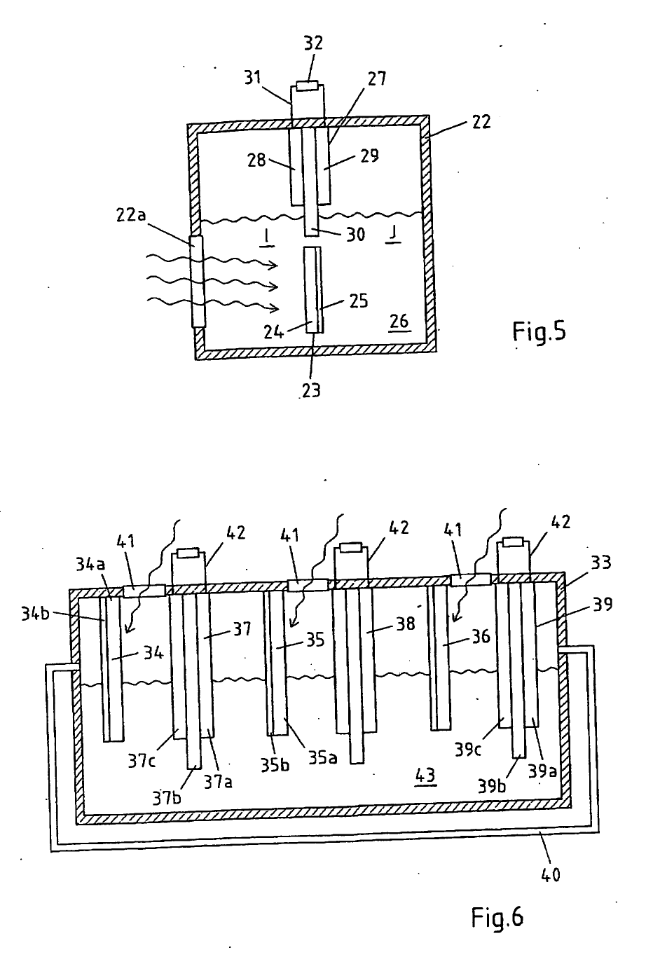

FIG. 5 the reaction cell of FIG. 1 with an integrated fuel cell and

FIG. 6 the reaction cell of FIG. 5 in a different embodiment with respect to FIG. 1 with three pairs of electrodes and three fuel cells in lateral sectional view.

The reaction cell of FIG. 1 is provided with a housing 1 closed to all sides with two gas outlets 1a, 1b and an irradiation window 2.

The irradiation window consists of an UV transparent material such as quartz glass which is preferably supplementary provided with an antireflex layer. The light L of an external light source, preferably sun light, can shine in the housing through the irradiation window 2. The housing 1 is filled up with an aqueous electrolyte 3, in this case water (aqua bidest). A pair of electrodes consisting of a first electrode 4 of a doped semiconductor and a second electrode 5 of metal is immersed in the electrolyte 3. In this case the first electrode 4 consists of an n-doped TiO₂-crystal having the shape of a plate while the second electrode S consists of a platinum layer that is vaporized to the TiO₂-crystal at one side the way that there is a contact in a flat manner between both electrodes 4 and 5. The pair of electrodes is arranged in the reaction cell 1 the way that the surface 4a of the first electrode that is not vaporized is irradiated by the light L shinning in the reaction cell 1 and that the cell is separated in two chambers A, B which are connected to each other in a liquid conducting manner.

At the contact surface I between the first electrode 4 and the electrolyte 3, an electrical field in the n-doped TiO₂-crystal of the first electrode is formed by electrons flowing off in the electrolyte. At the same time, there is an ohmic contact at the contact surface II between the semiconductor and the vaporized layer of platinum the way that a free exchange of charge carriers is possible here. If the surface 4a of the first electrode 4 is then irradiated by light, electron-hole pairs are produced in the complete semiconductor crystal of the first electrode.

While by recombination, they almost completely disappear again in the complete crystal, the electrons are separated from the holes at the region of the contact surface I where the electrical field is effective.

While the electrons in the conduction band of the semiconductor run off to the inside of the crystal toward the second electrode, the holes remain at the contact surface I and oxidize there the oxygen contained in the water molecules to oxygen gas according to reaction equation:

H₂0+2h⁺→½O₂+2H⁺

Contrary to this, the electrons pass the contact surface II between the first and the second electrode and reduce the hydrogen ions (protons) to hydrogen gas at the contact surface III between the second electrode 5 and the electrolyte 3:

2H⁺+2e⁻−>H₂

For this purpose, the hydrogen ions which are combined to neutral hydrogen molecules forming positively charged oxonium ions H₂O⁺ have to move from the contact surface I to contact surface III through the electrolyte 3 which is easily possible due to the connection in a liquid conducting manner between the chambers A, B. The gases formed in the photoelectrochemical reaction, hydrogen and oxygen, can then escape separately through the gas outlets 1a, 1b out of the reaction cell and are guided in gas accumulators that are not shown. Doing so, as it is visible in FIG. 1, a mixture of gases is excluded.

A reaction cell with a pair of electrodes of which the first electrode consists of a n-doped semiconductor and the second electrode a p-doped semiconductor is not shown. An electrical field is created at each contact surface, namely electrolyte n-semiconductor, pn-junction and p-semiconductor electrolyte. The electrical field leads to a band distortion like stairs over the complete breadth of the pair of electrodes. In the field region, electrodes-hole pairs formed by incidence of radiation can be separated in the above mentioned way wherein electrons move to the surface of the second electrode and the holes move to the surface of the first electrode.

The reaction cell shown in FIG. 2 is also provided with a housing 1 closed to all sides as well as an irradiation window 2 at the side and is filled up with water as electrolyte 3. Different to the reaction cell of FIG. 1, the cell shown in FIG. 2 is provided with three pairs of electrodes 6, 7, 8, wherein the respective first electrodes 9, 10, 11 of the three pairs of electrodes 6, 7, 8 consist of different semiconductor materials that are n-TiO₂, n-SrTiO₃ and n-GaAs. The second electrodes 12, 13, 14 of the pairs of electrodes 6, 7, 8 each consist of a thin platinum layer vapour deposited on the corresponding first electrode 9, 10, 11. The pairs of electrodes 6, 7, 8 separate the reaction cell in totally four chambers C, D, E, F connected to each other in a liquid conducting manner wherein a gas outlet 1c, 1d, 1e, 1f is assigned to each chamber.

Furthermore, pairs of electrodes 6, 7, 8 are arranged behind each other in the direction of the incidence of the light wherein the first and the second electrodes of the pairs of electrodes 6, 7, 8 face each other. With other words, the center pair of electrodes 7 is arranged mirror-inverted with respect to the external pairs of electrodes 6, 8.

The same electrochemical processes occur at the three pairs of electrodes 6, 7, 8 like in case of the pair of electrodes of the reaction cell shown in FIG. 1, that is at the respective first electrodes 9, 10, 11 the oxygen contained in the water molecules is oxidized to oxygen gas while at the respective second electrodes 12, 13, 14 hydrogen gas is produced. The layer thickness of the electrodes of the first and the second pairs of electrodes 6, 7 must be chosen small enough the way that the light shining in the cell penetrates them partly and is finally completely absorbed in the third pair of electrodes 8.

The particular advantage of the reaction cell shown in FIG. 2 now consists of the fact that due to the different band gap of the semiconductor materials of the respective first electrodes 9, 10, 11 of the pairs of electrodes 6, 7, 8 the light radiated in the cell is absorbed only in a certain spectral region in each pair of electrodes and is converted in reaction energy the way that a very wide spectral range for the photoelectrochemical reaction is used in the sum and so, the reaction cell can work with a remarkably higher operation ratio than a cell that is provided with only one pair of electrodes.

Due to the chosen arrangement of pairs of electrodes 6, 7, 8 in the cell in which the center pair of electrodes 7 is arranged mirror-inverted with respect to the other pairs of electrodes only one kind of gas is produced in the different individual reaction chambers C, D, E, F, namely oxygen gas in the chambers C and E and hydrogen gas in the chambers D and F, respectively, the way that there is no risk of gas mixture.

The reaction cell according to the invention shown in the example of construction represented in FIGS. 3 and 4 is provided with a essentially rectangular housing 15 that is made of a material impervious to light, preferably aluminium, stainless steel, nickel, brass, copper and gold. The housing 15 surrounds an essentially cubic intern reaction space which is open to one side. This opening is closed tight by a irradiation window 16. The window is transparent for visible light and also particularly for UV radiation. Therefore it is preferably made of quartz glass, Plexiglas, ZnSe, ZnS, borosilicate glass, MgF₂ and sapphire. Within the reaction space, a pair of electrodes is held by a holding arm 15g that is vertically extending down from the top of the space wherein the pair of electrodes is surrounded by an isolating layer that is not shown that prevents an electrical contact between the electrodes 17, 18 and the holding arm 15g. The pair of electrodes is composed of a first electrode 17 which preferably consists of an n-doped TiO₂-crystal, and a platinum layer vapour deposited on it as second electrode 18. The holding arm 15g holding the pair of electrodes is arranged in the reaction space the way that it separates the space together with the pair of electrodes in two chambers G, H of essentially the same size.

Furthermore, the housing is provided with bore holes 15a, 15b arranged from the top of the reaction space to the top of the housing in which gas conductions 15c, 15d are set in a tight manner. By means of these, gases produced in the chambers G, H can run off in gas accumulators that are not shown. Practically, gas conductions 15c, 15d can be shut down tight by valves 15e, 15f to avoid contamination of the reaction space in case of transport of the reaction cell.

If the reaction space of the reaction cell is full of water and if light is radiated in the reaction space, the above detailed photoelectrochemical reaction takes place wherein oxygen gas is produced in the chamber G at the surface of the n-semiconducted (n-doped) first electrode 17 and hydrogen gas is produced in the chamber H at the surface of the second electrode 18.

The reaction cell according to FIG. 5 is provided with a pair of electrodes 23 consisting of a first electrode 24 of n-doped TiO₂ and a second electrode 25 of a vapour deposited platinum layer. The pair of electrodes which divides the reaction cell in two chambers I, J is fixed at the lower internal surface of the housing 22 of the reaction cell by means of a holding arm (not shown) which does not disturb an exchange of liquid, particularly an exchange of ions between both chambers I, J. Furthermore, an irradiation window 22a is integrated in this housing.

An anode-cathode arrangement 27 that is formed as a fuel cell is placed above the pair of electrodes 23. The fuel cell is formed as a low temperature fuel cell and comprises a cathode 28, an anode 29 as well as a proton permeable membrane 30 arranged between them, preferably made of a perfluorated plastic of about 0.1 mm thickness.

The cathode 28 and the anode 29 are conductively connected to each other by means of an extern electric circuit 31, with other words arranged outside the reaction cell. In the electric circuit 31, an electrical consumer 32 such as an incandescent lamp or an electric motor is integrated. The reaction cell is filled with water as electrolyte 26 preferably that far that the pair of electrodes 23 is completely immersed in and the membrane 30 of the fuel cell is preferably immersed in the electrolyte 26.

In case of radiation on the surface of the first electrode 24, oxygen gas (chamber I) is formed there while hydrogen gas (chamber J) is produced on the surface of the second electrode 25. Then, the gas flows rising up separately in both chambers I, J flow around the electrodes 28, 29 of the fuel cell after escaping the electrolyte. Doing so, hydrogen at the anode 29 is oxidized by releasing its electrons while oxygen is reduced at cathode 28. The electrons necessary for this purpose move from the anode 29 to the cathode 28 through the external electric circuit 31. At the same time, the hydrogen ions move through to the membrane 30 and react with the oxygen ions to water. This runs off the membrane 30 and this way, renews the electrolyte 26 in the reaction cell. By means of this system, a closed circuit is established wherein the light energy is converted to electric energy.

The reaction cell filled with water 43 as electrolyte according to FIG. 6 comprises totally three pairs of electrodes 34, 35, 36 as well as three fuel cells 37, 38, 39 arranged in alternating order in between. Every fuel cell is provided with an external electric circuit 42 with an electrical consumer.

The function of this cell should be explained referring to the example of fuel cell 37 and both neighbouring pairs of electrodes 34, 35:

By means of the light falling diagonally from top through the window 41 on the first electrode 34a (n-doped semiconductor) of the pair of electrodes 34, oxygen gas is produced on it while hydrogen gas is produced at the second electrode 34b (metal). The produced oxygen meets the cathode 37c of the fuel cell 37 where it is reduced. At the same time, hydrogen gas is produced at the second electrode 35b of the pair of electrodes 35 which is oxidized at the anode 37a of the fuel cell 37. The ionised hydrogen passes the membrane 37b of the fuel cell 37 and reacts with the oxygen of the cathode to water which renews the stock of electrolyte 43.

The hydrogen produced at the second electrode 34b of the pair of electrode 34 is guided through the ring conduction 40 to the other side of the reaction cell where it is oxidised at the anode 39a of the fuel cell 39 and reacts with oxygen to water.

By means of this multiple arrangements, a particularly efficient system is created which provides several current sources corresponding to the number of the used units of fuel cells which can also be connected in parallel.

1-30. (canceled)

31. A reaction cell for the photoelectrochemical production of hydrogen gas, comprising a housing which is filled with an aqueous electrolyte, a pair of electrodes consisting of a first electrode made of a doped semiconductor which is immersed in the electrolyte and a second electrode made of metal or an oppositely doped semiconductor with respect to the first electrode which is electroconductively connected to the first electrode and is immersed in the electrolyte, wherein the pair of electrodes subdivides the reaction cell in two chambers, wherein the chambers are connected to each other in a liquid conducting manner and a light source which irradiates the pair of electrodes, and wherein the electrodes are connected to each other in a flat and direct manner and the housing comprises at least one gas outlet.

32. The reaction cell according to claim 31, wherein the electrodes are connected to each other in a flat manner at the backside of the first electrode with respect to the light incidence.

33. The reaction cell according to claim 31, wherein the second electrode is vapour deposited at one side of the first electrode.

34. The reaction cell according to claim 31, wherein the electrodes are designed in a flat manner, particularly having the shape of a plate each.

35. The reaction cell according to claim 31, wherein sun light is used as the light source.

36. The reaction cell according to claim 31, wherein the housing of the reaction cell consists of a light transparent material, particularly Plexiglass.

37. The reaction cell according to claim 31, wherein the housing of the reaction cell consists of a material impervious to light and is provided with a window for light irradiation.

38. The reaction cell according to claim 37, wherein the window consists of a UV transparent material.

39. The reaction cell according to claim 38, wherein the UV transparent material is a material of the group quartz glass, Plexiglass, ZnSe, ZnS, Borosilicate glass, MgF₂ and sapphire.

40. The reaction cell according to claim 31, wherein the housing is closed to all sides except for at least one gas outlet.

41. The reaction cell according to claim 40, wherein the at least one gas outlet can be closed tight by means of a valve.

42. The reaction cell according to claim 40, wherein the two chambers formed by the pair of electrodes in the cell are each provided with a gas outlet.

43. The reaction cell according to claim 31, wherein the reaction cell comprises a heat exchanger.

44. The reaction cell according to claim 31, wherein the reaction cell is operated with water as the electrolyte.

45. The reaction cell according to claim 44, wherein the water is mixed with antifreezing agent.

46. The reaction cell according to claim 31, wherein the first electrode consists of a semiconductor of the group TiO₂, SrTiO₃, Ge, Si, Cu₂S, GaAs, GaP, ZnO, WO₃, CdS, MoS₂, CdSeS, SnO₂, SiC, Pb₃O₄, CdSe.

47. The reaction cell according to claim 31, wherein the semiconductor is n-doped.

48. The reaction cell according to claim 31, wherein the semiconductor is p-doped.

49. The reaction cell according to claim 46, wherein the irradiated surface of the first electrode is formed as (110)- or (100)-crystal surface of a TiO₂-crystal.

50. The reaction cell according to claim 31, wherein a colorant is adsorbed on the surface of the first electrode.

51. The reaction cell according to claim 31, wherein platinum clusters are adsorbed on the surface of the first electrode.

52. The reaction cell according to claim 31, wherein the second electrode consists of a metal of the group Ru, Rh, Pd, Ag, Os, Ir, Pt, Au, Al, Cr, Cu, Ni, Mo, Pb, Ta, W.

53. The reaction cell according to claim 31, wherein a plurality of pairs of electrodes is provided, and wherein the respective first electrodes of the pairs of electrodes consist of different semiconductor materials.

54. The reaction cell according to claim 53, wherein the pairs of electrodes are arranged one behind the other in the direction of light incidence, and wherein the first and the second electrodes of the pairs of electrodes are facing each other.

55. The reaction cell according to claim 54, wherein the respective first electrode of the pairs of electrodes arranged one behind the other in radiation direction has a smaller band gap with respect to the first electrode of the pair of electrodes that is arranged ahead in radiation direction.

56. A device for converting light energy to electrical energy comprising a reaction cell according to claim 31, wherein an anode-cathode arrangement in the reaction cell or in another cell that is connected to the reaction cell through at least one gas conduction is provided, wherein the anode and the cathode are conductively connected to each other through an external electric circuit to which an electrical consumer can be connected, and wherein the anode and the cathode are arranged such that the gas produced at the first and the second electrode of the pair of electrodes flows around the anode and the cathode.

57. The device according to claim 56, wherein the anode-cathode arrangement is formed as a fuel cell.

58. The device according to claim 57, wherein the fuel cell is designed as a low temperature fuel cell.

59. The device according to claim 57, wherein several pairs of electrodes and several fuel cells are arranged in alternating order beside each other, and wherein an external consumer can be connected to the respective external electric circuit of fuel cells.

60. The device according to claim 56, wherein the anode-cathode arrangement is arranged in another cell and is formed as a galvanic cell.
